(19) United States
(12) Patent Application Publication
(10) Pub. No.: US 2019/0127936 A1
(43) Pub. Date: May 2, 2019

(54) Seawalls with articulated water-facing surfaces with protrusions and extensions

(71) Applicant: Keith Van de Riet, Lawrence, KS (US)

(72) Inventor: Keith Van de Riet, Lawrence, KS (US)

(21) Appl. No.: 16/350,300

(22) Filed: Oct. 29, 2018

Related U.S. Application Data
(60) Provisional application No. 62/578,074, filed on Oct. 27, 2017.

(51) Int. Cl. E02B 3/04; E02D 29/02

(52) U.S. Cl. CPC E02B 3/046; E02B 3/066; E02D 29/0266

(57) ABSTRACT

A seawall may have an articulated sea-facing surface that forms pockets, tunnels, and other irregular surfaces that provide habitat for aquatic life. The seawall may be formed from panels of cast concrete, with the panels having protrusions extending from the sea-facing side. Extensions may be affixed to cast panels to further enhance the habitat created by the seawall and to attenuate incident waves.

### CROSS-REFERENCE TO RELATED APPLICATIONS

This patent application claims priority to U.S. Provisional Patent Application Ser. No. 62/578,074, filed on Oct. 27, 2017, entitled “SEAWALLS WITH ARTICULATED WATER-FACING SURFACES,” which is incorporated by reference.

### FIELD OF INVENTION

The present invention relates to seawalls. More particularly, the present invention relates to seawalls that provide habitat and efficient attenuation of incident forces from the water-facing side of the seawall.

### BACKGROUND AND DESCRIPTION OF THE RELATED ART

Seawalls are commonly used to prevent coastal erosion and/or flooding. While useful for protecting human interests from the power of the sea, seawalls disrupt the ecosystems of tidal areas. Conventional seawalls are also subject to wear and degradation, especially scouring of the wall and seafloor at the bottom of the wall, and therefore require maintenance and/or replacement to protect human interests.

### SUMMARY OF THE INVENTION

Systems and methods in accordance with the present invention retain and improve upon the protective properties of seawalls for human interests while providing habitat for species that would typically populate a tidal region unmodified by human encroachment. The resulting seawalls are aesthetically pleasing to humans while remaining inexpensive and simple to install or deploy. In some examples in accordance with the present invention, a marine-friendly seawall may be created as a new construction, while in other examples in accordance with the present invention a marine friendly seawall may be created by retrofitting an existing seawall.

Rather than presenting a relatively flat and smooth surface to a water-facing side, a marine-friendly seawall in accordance with the present invention may provide an irregular surface with a variety of pockets, tunnels, and gaps. An irregular surface in accordance with the present invention may comprise a non-planar face with undulations, irregularities, protrusions, and/or extensions. An irregular surface may additionally/alternatively comprise extensions that may be made of a different material than the seawall itself that extend from the surface of the seawall into the water. In addition to providing habitat for marine species, such an articulated surface better attenuates the energy of waves impacting the seawall than does a relatively flat, planar surface. Clapotic waves can be particularly damaging to conventional, substantially planar seawalls, but the articulated surface of seawalls in accordance with the present invention can prevent a standing clapotic wave from forming by presenting an irregular surface to the water-facing side of a seawall. Systems and methods in accordance with the present invention provide improved performance relative to conventional seawalls from both the perspective of marine life and humans.

In accordance with the present invention, an articulated water-facing surface may be created for a seawall by additive manufacturing and/or by casting a material, such as concrete, in a mold, such as a mold formed from silicone rubber. Portions of a seawall in accordance with the present invention may be formed in modules having a size that enables them to be processed, handled, and assembled to form a seawall having a desired water-facing surface. For example, the water-facing surface of a seawall may be formed as a series of panels with the same, different or similar articulated surfaces. A mold used to cast modules for a seawall in accordance with the present invention may be formed by creating a model of the desired articulated seaward surface of the seawall that provides pockets, tunnels, and gaps. Such a model may be carved into a material (such as a polystyrene foam), sculpted out of a material (such as various clays), and/or through a combination of carving and sculpting materials. Silicone may then be applied to the model of the seaward surface and, once set, the silicone may be removed and used as a negative for casting the concrete used in the seawall. While materials such as polystyrene foam and clay (for model formation) and silicone rubber (for mold creation) are described in examples herein, any other material may be used to from models and/or molds. Similarly, while concrete has been described in examples herein as a material that may be cast to form modules for assembly into a seawall, other materials may be cast, assembled, grown, machined, or otherwise formed into all or part of a seawall in accordance with the present invention.

Models may be formed using polystyrene foam and/or other materials that may be formed into the desired shape for the eventual seawall. Polystyrene foams may be used in some examples in accordance with the present invention, as polystyrene is inexpensive and relatively simple to carve into a desired shape. Foam may be carved into the shape desired for the water-facing side of a seawall through milling or other automated or semi-automated processes. In some examples, foam may be carved into the shape desired for the water-facing side of a seawall by individuals using hand tools, whether powered or unpowered. In yet further examples, foam may be carved into the rough shape desired for the seaward face of the seawall using automated or semi-automated processes, and then individuals using hand tools may refine the foam to create the shape ultimately used to form the silicone mold. Additionally/alternatively, a material such as clay may be sculpted to form the model of desired seawall. In some examples, a foam base may be formed through carving, and then protrusions formed from sculpted clay may be added to the foam to produce a model.

After a model has been created, silicone rubber may be cast around the model to produce a mold for use in casting concrete or any other material to be cast to form the seawall panel or module. After curing, the silicone mold may be removed from the model by peeling the silicone from the model and/or destroying the material (such as polystyrene foam) used to create the model.

One or more module of a seawall in accordance with the present invention may be formed by pouring concrete into a silicone mold formed as a negative representation of the water-facing surface of the seawall. Other features, such as attachment points or mechanisms, may optionally be formed using a mold as well, in order to facilitate the construction or assembly of a seawall from the modules. Modules may comprise an entire panel of a seawall that extends from the top of the seawall to the bottom of the seawall, but modules may also comprise square, rectangular, or other geometric shapes that may be combined horizontally and/or vertically to form a seawall, thereby providing a great deal of configurability to a seawall from a limited number of module designs (or even a single module design). In many examples in accordance with the present invention, silicone molds may be re-used to cast multiple modules for use as all or part of a water-facing surface of a seawall in accordance with the present invention. In order to permit the non-destructive removal of a silicone mold from cast modules, cuts may be made in the silicone of the mold prior to casting the concrete, particularly to permit tunnels to be formed in the concrete while still permitting the silicone mold to be removed from the cast concrete and re-used.

In some examples, a supporting structure or framework may receive and retain modules cast in accordance with the present invention into a seawall. Such a framework or structure may comprise metal posts or pillars securely anchored to the ground/seafloor, as well as optionally horizontal support members extending between the pillars or posts. Modules may be anchored to such a supporting structure to be retained in a desired orientation for a completed seawall to provide habitat for marine species, to attenuate the energy of waves, and/or to provide an aesthetically pleasing structure for humans.

The patterns of undulation and/or articulation of a water-facing surface of a seawall created using systems and methods in accordance with the present invention may optionally mimic a desired naturally occurring coastal ecosystem. In some examples described herein, the water-facing sides of seawalls may resemble mangrove roots, but other geometries, both resembling those found in nature and those uniquely human generated, may be created and deployed without departing from the scope of the present invention.

Seawalls in accordance with the present invention may be limited to a single cast module (or series of cast modules) having articulated water-facing surfaces, but in some examples additional extensions may be affixed to a seawall. For example, extensions may extend from the water-facing surface of a seawall and reach into the water a predetermined distance, optionally extending in an arcing or curving fashion. In some examples such extensions may have a substantially circular or elliptical cross section and may be cast of concrete using systems and methods such as those described herein and either temporarily or permanently affixed to a seawall. In other examples, however, such extensions may be formed from one or more material that differs from the material (such as concrete) used to form the water-facing surface of the seawall. For example, nylon rope, natural fiber rope, rubber rods or other structures, cast or extruded plastic structures, wood, and/or other materials may be affixed to a water-facing surface of one or more seawall modules in accordance with the present invention. Such extensions may provide a further varied habitat along the seawall while also further dispersing the energy of waves incident upon the seawall.

In yet further examples, additional freestanding structures may be associated with a seawall in accordance with the present invention. Such freestanding structures may be cast of concrete and/or formed from other materials and deployed beyond the seawall formed in accordance with the present invention. Such freestanding structures may provide additional habitat and further wave dissipation.

In accordance with the present invention, the water-facing surface of a seawall may comprise a plurality of curving protrusions having a roughly circular or elliptical cross-section. The protrusions created in accordance with the present invention may be formed from concrete or other materials that may be deployed in a marine environment. In some examples, the protrusions formed in the water-facing surface of a seawall may resemble a root system such as found in a coastal mangrove forest, thereby creating a plurality of tunnels, pockets, and holes for various species of marine life to thrive. Meanwhile, the plurality of protrusions in the resulting structure will diffuse waves incident upon the seawall.

In some examples in accordance with the present invention, protrusions formed in accordance with the present invention may be limited to protrusions extending from an undulating surface formed in a panel used to create a seawall. In such an example, the depth of protrusions would be limited to that which could be casted integral with the panel itself. In such an example, regulatory considerations may also require that the depth of protrusion fall within specific parameters. The total depth of protrusion in such an example may vary based upon both the appropriate regulatory considerations and the physical properties (such as the size of the panel, the type of concrete being used, any internal supports provided for the concrete, etc.) of the seawall.

In other examples of seawalls in accordance with the present invention, an existing seawall having a substantially planar water-facing surface may be retrofit with an undulating surface. Such an undulating surface may be formed as a panel (or a series of panels) that is affixed to the existing seawall to retain the undulating surface in a desired configuration relative to the water and the pre-existing seawall.

In further examples of seawalls in accordance with the present invention, extensions may be affixed to the water-facing side of a seawall. Such extensions may be formed of the same material as the seawall itself, such as concrete, but may additionally/alternatively may be formed of a different material than the seawall, such as a pliable material. Such extensions may comprise arcing structures that extend various distances into the water.

In yet further examples of seawalls in accordance with the present invention, freestanding structures may be erected in the water beyond the water-facing surface of the seawall and any optional extensions extending from the seawall. Such structures may comprise a plurality of arcing or curving concrete structures affixed to the seafloor, although materials other than concrete may be used within the scope of the present invention.

By providing multiple types of structures that produce a variety of pockets or tunnels that may extend varying distances from a seawall, systems and methods in accordance with the present invention may be adapted for use in a wide variety of coastal conditions and circumstances and may be deployed in a variety of regulatory contexts. Further, by providing varying degrees of roughness or undulation on the water-facing surface of a seawall in accordance with the present invention, marine life such as shellfish may more readily latch onto the surface. By providing protrusions, extensions, and/or freestanding structures that extend into the water, the present invention permits greater or lesser amounts of wave attenuation as desired and appropriate for a given seawall installation. Further, the infinite variety of configurations attainable for seawalls using systems and methods in accordance with the present invention provide a wide range of aesthetic options that may be modified based upon the preferences of humans living, working, or playing near the seawall.

In addition to providing a physical geometry suitable for a coastal ecosystem by providing articulated surfaces in conjunction with seawalls, in some examples in accordance with the present invention some or all of the surfaces contacting the water may be treated to render those surfaces even more desirable for habitat purposes. For example, “oyster flour” formed from crushed oyster shells may be applied to the surface of concrete formed for the water-facing side of a seawall in accordance with the present invention. Some or all of the surfaces of a seawall in accordance with the present invention, protrusions from a seawall in accordance with the present invention, and/or freestanding structures associated with a seawall in accordance with the present invention may be dusted or powdered with oyster flour or other material. In other examples, oyster flour or other materials may be integrated into the concrete prior to casting. In yet further examples, oyster flour or other materials may be applied to the surface of a mold used to form concrete into a desired shape. Oyster flour is merely one example of a material that may be applied to encourage the use of the pockets, holes or tunnels of an undulating surface of a seawall in accordance with the present invention for habitat purposes. A variety of materials may be used instead of or in addition to oyster flour. Different materials may be particularly appropriate for different coastal environments.

### BRIEF DESCRIPTION OF THE SEVERAL VIEWS OF THE DRAWINGS

Examples of systems and methods in accordance with the present invention are described in conjunction with the attached drawings, wherein:

FIG. 1 illustrates a perspective view of an example of a seawall in accordance with the present invention;

FIG. 2 illustrates an example of components of a seawall in accordance with the present invention being installed;

FIG. 3 illustrates an example of casting a panel for a seawall in accordance with the invention;

FIG. 4 illustrates a method for erecting a seawall in accordance with the present invention;

FIG. 5 illustrates an example of forming a mold for a seawall in accordance with the present invention;

FIG. 6 further illustrates forming a mold for a seawall in accordance with the present invention;

FIG. 7 further illustrates forming a mold for a seawall in accordance with the present invention;

FIG. 8 further illustrates forming a mold for a seawall in accordance with the present invention;

FIG. 9 illustrates an example of casting a panel for a seawall in accordance with the present invention;

FIG. 10 further illustrates an example of casting a panel for a seawall in accordance with the present invention;

FIG. 11 further illustrates an example of casting a panel for a seawall in accordance with the present invention;

FIG. 12 illustrates an example of a panel for a seawall in accordance with the present invention;

FIG. 13 illustrates a further example of a panel for a seawall in accordance with the present invention;

FIG. 14 further illustrates an example of a panel for a seawall in accordance with the present invention;

FIG. 15 illustrates an example of a panel in accordance with the present invention installed.

### DETAILED DESCRIPTION

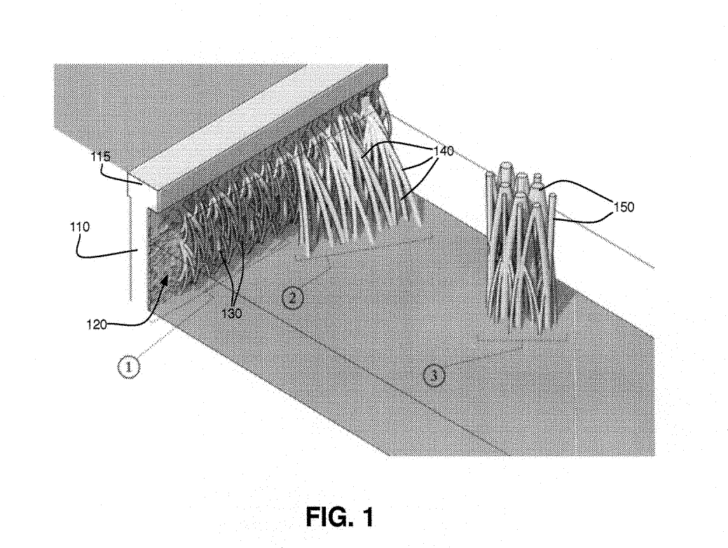

FIG. 1 depicts one example of a seawall in accordance with the present invention. A module may comprise a panel 110 that may extend in a substantially planar fashion vertically from a top 115 downward below the surface of the water. A plurality of panels 110 may be used to form a length of seawall. The water-facing surface 120 of the panel 110 may be rough or irregular rather than flat and planar, as depicted in the example of FIG. 1. A plurality of primary protrusions 130 integral to the cast panel 110 may extend from the surface 120 of panels 110 to form pockets or tunnels within those protrusions and between the protrusions 130 and the surface 120 of the panels 110. Additional extensions 140 may be formed separate from any panel 110 and affixed to panels 110 to extend beyond the integral protrusions 130 to create an extended distance of habitat and wave attenuation into the water. Freestanding structures 150 associated with the seawall may be erected in the water beyond the integral protrusions 130 and/or the affixed protrusions 140. Freestanding structures 150 may provide yet additional habitat and wave attenuation for a seawall in accordance with the present invention.

Various physical and geometric aspects of a seawall such as depicted in the example of FIG. 1 may be varied to create a desired type or amount of habitat and a desired degree of wave attenuation. For example, the amount of roughness associated with the surface 120 of panels 110 may be varied. For example, the frequency and/or magnitude of undulation in the surface may be varied, for example by controlling the frequency and/or magnitude of undulation created in the model used to produce a mold. Further, the number, density, diameters, and/or curvature(s) of primary protrusions and/or extensions may be varied, as may the number, density, diameters, and/or curvature(s) of elements of any freestanding structures 150. Further, the distance(s) that any integral protrusions 130 extend, the distance(s) that any affixed extensions 140 extend, and the distance(s) at which any freestanding structures 150 are positioned may be modified to achieve a desired habitat, visual aesthetic, and/or degree of wave attenuation. In some examples, any integral protrusions provided may extend up to eighteen inches into the water, any affixed extensions provided may extend up to four to five feet into the water, and any freestanding structures provided may be positioned up to fifteen to twenty feet into the water, but such distances are exemplary only.

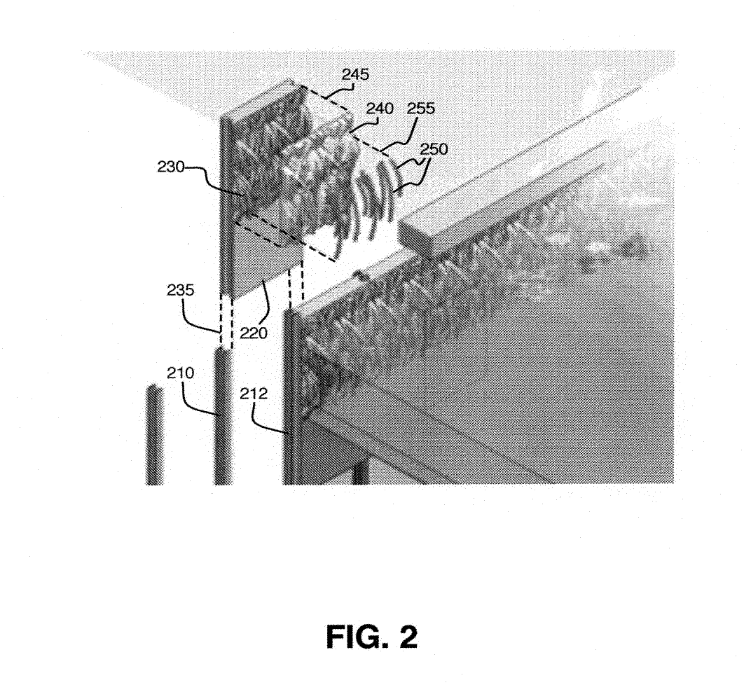

Referring now to FIG. 2, a further example of a seawall in accordance with the present invention is illustrated. A seawall may be constructed by inserting 235 a plurality of modules, such as panel 220, that are retained b a supporting structure(s), such as first pillar 210 and second pillar 212. Panel 220 may provide an irregular water-facing surface and a plurality of primary protrusions 230. In some examples, such as for use in a retro-fit of an existing planar seawall, the maintenance of a seawall with an articulated surface such as provided in accordance with the present invention, and/or for the enhancement of a seawall with an articulated surface in accordance with the present invention, an overlay 240 of cast concrete providing an irregular surface and/or primary protrusions may be affixed 245 to a panel of a seawall. Extensions 250 may be affixed 255 to an overlay 240 and/or to a panel 220 to provide a further extension of the habitat and/or wave attenuating structure in accordance with the present invention.

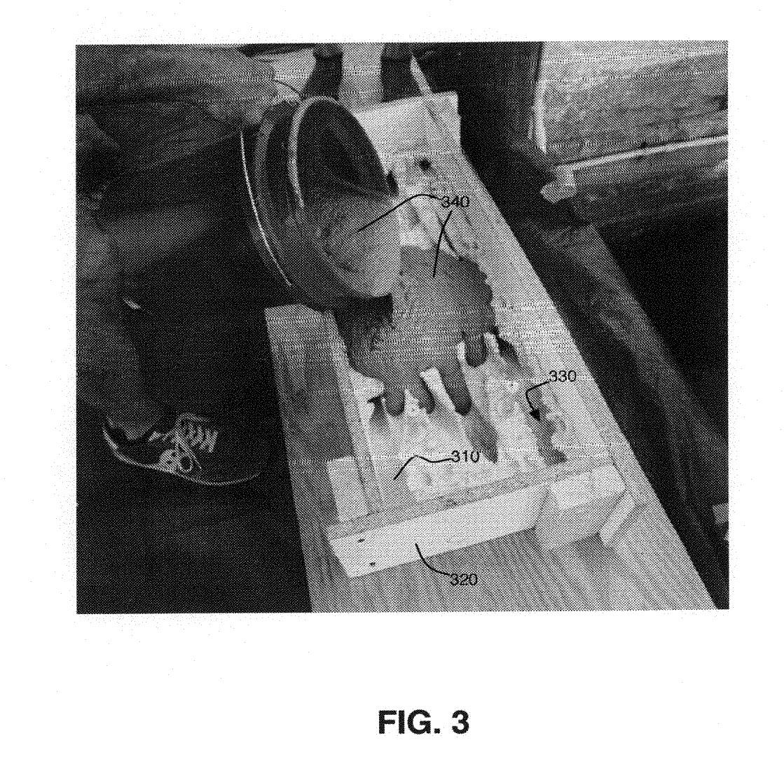

FIG. 3 depicts an example of using a silicone mold 330 to cast concrete 340 for use as a module, an overlay, an extension, and/or as a freestanding structure in accordance with the present invention. Mold 330 may provide one or more cavity 310 with an undulating shape that forms the negative of the water-facing surface and/or primary protrusions in accordance with the present invention. A frame 320 may retain the silicone mold 330 for convenient casting of the concrete 340. Mold 330 may be removed from the cured concrete to permit the resulting panel/overlay/secondary protrusion/freestanding structure to be deployed. Silicone mold 330 may be re-used to form additional elements of a seawall in accordance with the present invention.

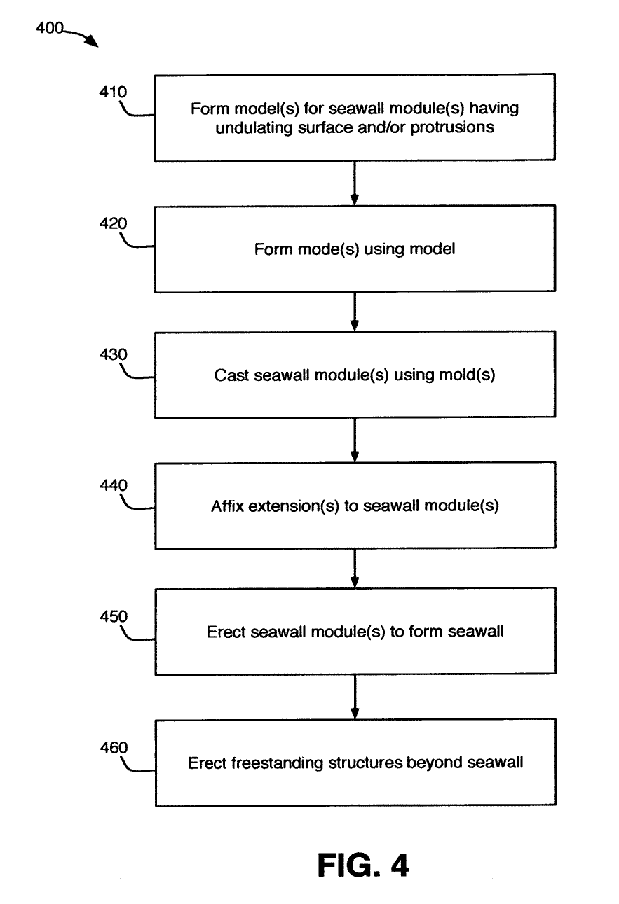

FIG. 4 depicts one example of a method 400 in accordance with the present invention for constructing seawalls. In step 410 a model of one or more module for a seawall may be formed. Step 410 may use polystyrene foam, clay, or any other material to form a model representative of a desired seawall module. Step 410 may create a model having an undulating surface corresponding to the water-facing surface of the eventual seawall module and/or protrusions extending from the water-facing surface of the seawall module. In step 420, one or more mold may be formed using the model(s) created in step 410. The mold(s) created in step 420 may be formed from a silicone rubber or other suitable material, which may be cast around the model(s) and then removed. In step 430 the mold(s) created in step 420 may be used to cast one or more seawall module. Step 430 may involve pouring concrete into the mold(s) created in step 420 and then removing the mold(s) from the cast module(s) when the concrete has adequately cured. In step 440, extensions may optionally be affixed to the seawall module(s) cast in step 430. The extensions optionally affixed to seawall modules in step 440 may be cast in a fashion similar to the modules themselves, but additionally alternatively the extensions may be formed from a different material having different properties than the material cast to form a seawall module. In step 450, the seawall modules may be erected to form a seawall by, for example, affixing the modules to a supporting structure to present the water-facing side of the module to the sea. In step 460, optional freestanding structures may be erected beyond the seawall. The freestanding structures erected in step 460 may be formed through a casting process similar to that described in exemplary method 400, but additionally/alternatively may be formed through other construction processes or may comprise naturally occurring items, such as boulders, positioned to create habitat and/or to dissipate the energy of waves approaching the seawall.

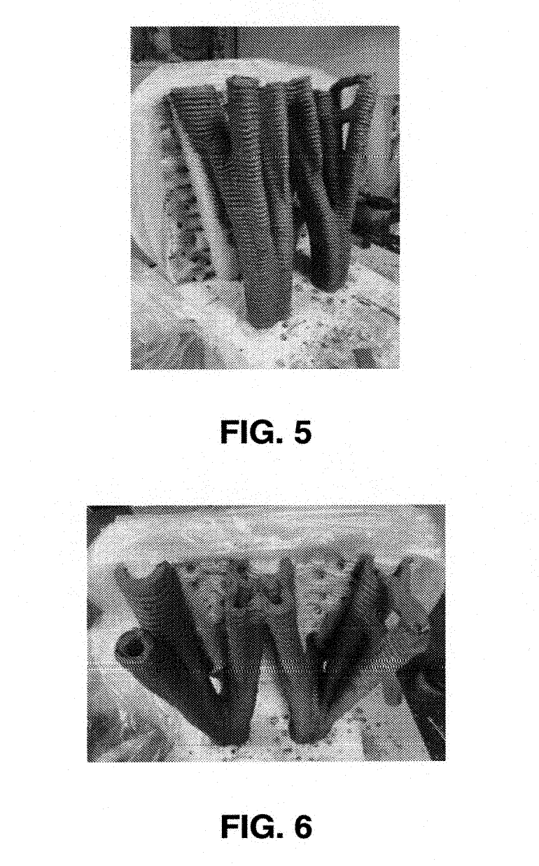

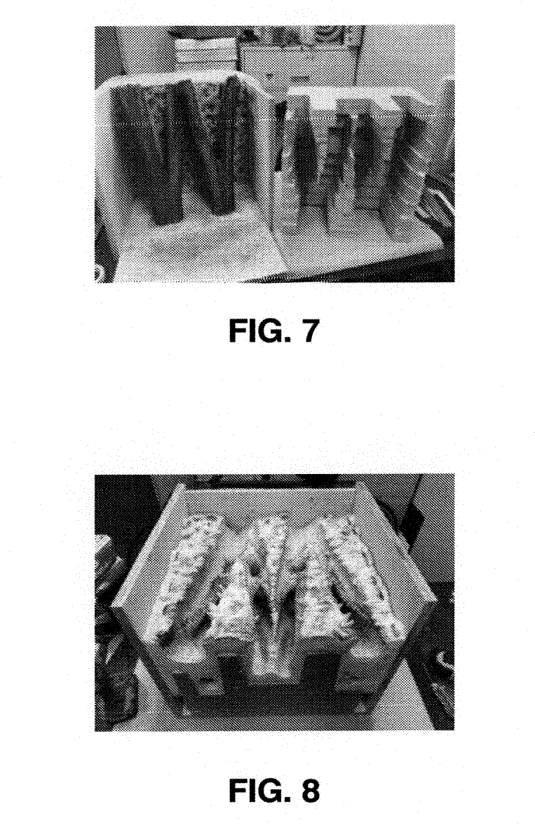

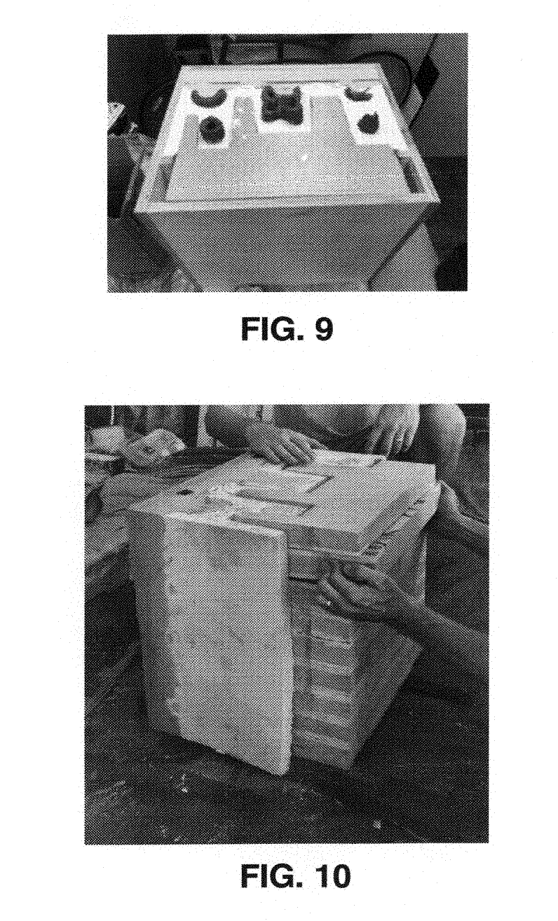

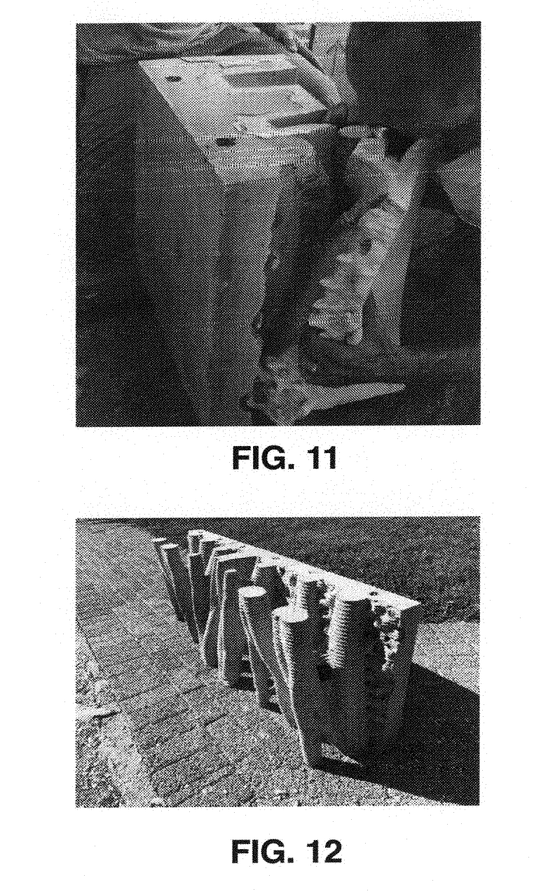

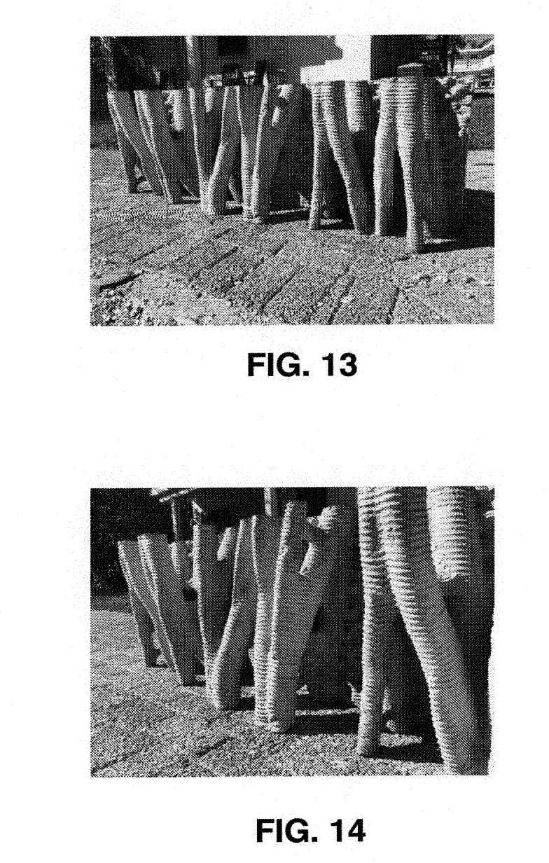

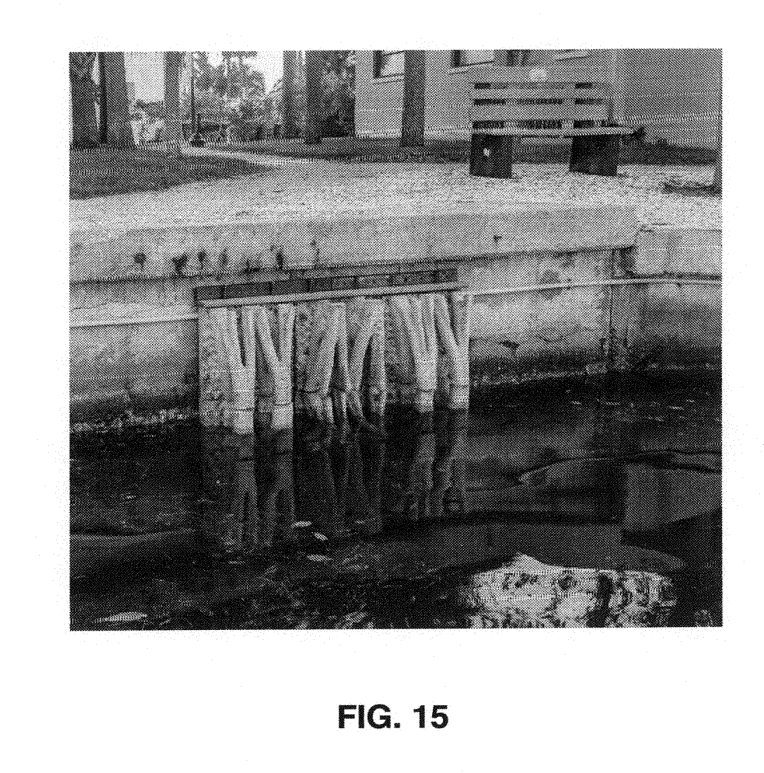

FIG. 5 and FIG. 6 illustrate an example of a model of a seawall module that has been created in accordance with the present invention. In the example of FIG. 5, a polystyrene portion has been carved to provide an undulating surface and clay portions have been sculpted and affixed to form protrusions. FIG. 7 shows an example of the model from FIGS. 5 and 6 as it is prepared for mold formation. A container, such as a wooden box, may be used to contain the mold material, such as silicone rubber, around the model, while one or more spacer may be used fill gaps and to avoid needless use of mold material. FIG. 8 shows an exemplary mold after it has been removed from a model. FIG. 9 shows an example of a mold containing concrete during the casting process. FIG. 10 and FIG. 11 show an example of the mold being removed from the cast concrete. Examples of modules produced using the exemplary model and mold from FIGS. 5-11 are shown in FIGS. 12-14. As illustrated in the example of FIGS. 12-14, modules may be assembled together to form a desired seawall configuration by altering the orientation of adjacent seawall modules. While modules may have different sizes, in some examples each module formed may occupy a seawall area of approximately 18 inches by 18 inches. An example of installed modules as part of a seawall is depicted in the example of FIG. 15.

In some examples in accordance with the present invention, one or more seawall module may be prepared using additive manufacturing processes, such as 3-D printing, rather than a casting process. In some further examples in accordance with the present invention, additive manufacturing processes may be used to add undulation, protrusions, and/or extensions to a module formed through casting.

By forming modules for use in constructing a seawall, construction of the seawall is facilitated by making individual components manageable during the construction process. For example, a module may be sized such that the mold for casting (if used) and the resulting module are of a size and weight that can be manipulated by those constructing the seawall. Further, the use of modules permits seawalls in accordance with the present invention to be adapted to provide a variety of habitats, even as part of a single seawall, by varying the size and type of undulations, protrusions, and extensions. The use of modules also permits the degree of wave attenuation to be modified for different seawalls constructed in accordance with the present invention and/or for different locations along a seawall in accordance with the present invention.

Systems and methods in accordance with the present invention permit the economical construction of seawalls with superior wave attenuation that also provide habitat in coastal areas. While describe in some examples herein as a seawall that mimics a coastal mangrove geometry such as may be suitable for deployment at locations such as, but not limited to, coastal Florida in the United States, other geometries may be created using systems and methods in accordance with the present invention. While seawalls in accordance with the present invention may be designed to mimic the geometry of a naturally occurring coastal ecosystem, systems and methods in accordance with the present invention may be used to create seawalls that differ or exceed naturally occurring geometries for wave attenuation, habitat creation, and/or visual appeal.

1. A seawall comprising:
a plurality of panels cast from concrete, each of the panels having a sea-facing side comprising an undulated surface and a plurality of protrusions extending from the surface;
a supporting structure that receives and retains the plurality of panels cast from concrete in an orientation that places the sea-facing side of the panels toward a body of water; and
a plurality of protrusions affixed to the sea-facing side of the plurality of panels, the plurality of protrusions extending from the sea-facing side into the body of water.

2. The seawall of claim 1, further comprising at least one structure placed at least five yards from the sea-facing side of a panel, the at least one structure comprising a plurality of protrusions cast from concrete.

3. The seawall of claim 2, further comprising a plurality of extensions formed from pliable material that are affixed to the sea-facing side of at least one panel.

4. The seawall of claim 1, further comprising a plurality of extensions formed from pliable material that are affixed to the sea-facing side of at least one panel.

5. The seawall of claim 1, wherein each of the plurality of panels is cast from a mold.

6. The seawall of claim 5, wherein each of the molds produces the same pattern of undulations and protrusions.

7. The seawall of claim 1, wherein the protrusions extending from the seawall provide a space between the protrusion and the sea-facing side of the seawall.

8. A method of forming a seawall, the method comprising:
forming a model of a sea-facing surface of a seawall panel, the model providing undulations on the surface and protrusions extending from the surface that provide a space between the surface and the protrusion;
forming a mold of the model from a pliable material;
casting a concrete panel using the mold, the cast concrete panel having a surface derived from the sea-facing surface of the model; and
affixing the cast concrete panel to a supporting structure such that the sea-facing surface of the concrete panel faces a body of water.

9. The method of claim 8, further comprising iteratively casting and affixing a plurality of concrete panels.

10. The method of claim 9, further comprising affixing a plurality of extensions from the sea-facing sides of the plurality of concrete panels.

11. The method of claim 10, wherein the plurality of extensions comprise a pliable material.

12. The method of claim 10, wherein at least some of the plurality of extensions comprise rope.

13. The method of claim 10, wherein at least some of the plurality of extensions comprise wood.

14. The method of claim 10, wherein the supporting structure comprises at least a portion of a pre-existing seawall.

15. A seawall panel comprising:
a sea-facing surface having a plurality of undulations over a majority of the surface and a plurality of protrusions extending from the surface, such that a space is created between the protrusion and the surface;
at least one affixment mechanism on the side of the panel opposite the sea-facing surface, the at least one affixment mechanism engaging with a support structure; and
at least one extension affixed to the sea-facing surface of the panel.

16. The seawall panel of claim 15, wherein the undulations and protrusions are formed from cast concrete.

17. The seawall panel of claim 16, wherein the extensions are not formed from concrete.
